(19) United States
(12) Patent Application Publication
(10) Pub. No.: US 2018/0330061 A1
(43) Pub. Date: Nov. 15, 2018

(54) Treatment Recommendation System And Method

(71) Applicant: Pinscriptive, Inc., San Juan Capistrano, CA (US)

(72) Inventors: Roni H. Amiel, Sparta, NJ (US); Fuad Rahman, Santa Clara, CA (US)

(21) Appl. No.: 15/592,064

(22) Filed: May 10, 2017

(51) Int. Cl. G06F 19/00

(52) U.S. Cl. CPC G06F 19/325; G06F 19/3431; G06F 19/328

(57) ABSTRACT

A treatment recommendation system includes a computing platform having a hardware processor and a system memory storing a treatment recommendation software code. The treatment recommendation software code receives use case and outcome history data for each of multiple treatments, extracts medical data for subpopulations within a cohort of subjects diagnosed with a condition treatable using the treatments, and transforms the use case and outcome history data and the medial data into value scores corresponding respectively to a value of each of the treatments for treatment of the condition in each subpopulation. The treatment recommendation software code also receives a query for treatment of the condition in a patient identified with one of the subpopulations, forecasts a risk of the condition progressing to an advanced stage for the patient, and generates one or more treatment recommendations for the patient based on the value scores and the risk.

### BACKGROUND

Advances in pharmaceutical and basic medical research have resulted in the availability of specialty drugs and new treatment protocols that give hope to many patients who previously had lacked effective treatment options. However, many of these new treatments are extremely costly, and leave insurers and other entities responsible for paying for patient care in the unenviable position of facing unsustainable costs, or denying access to powerful and beneficial treatments.

For example, specialty pharmaceutical drugs for use in the treatment of cancer, cystic fibrosis, multiple sclerosis, rheumatoid arthritis, and hepatitis C may cost anywhere from approximately ten thousand to approximately one hundred thousand dollars for a full course of treatment. Despite their nearly prohibitive costs, however, these specialty drugs can be life saving for some patients, so that simply denying access to them due to their expense is not an appropriate solution for achieving cost control.

One significant factor discouraging insurers and other healthcare payers from approving specialty drugs and other expensive treatment modalities more readily, is the cost associated with waste. Waste typically occurs because of a mismatch between a prescribed drug or treatment method and the patient receiving the treatment. For instance, certain individuals may have an adverse reaction to a drug, or may be relatively unresponsive to a particular treatment, where another patient would respond more favorably.

In addition to concern with waste, however, insurers and other healthcare payers must be cognizant of the costs associated with delaying approval of advanced treatments for some patients. For example, denial or delay of specialty drug treatment for hepatitis C may result in relatively rapid progression of advanced liver disease in some patients, resulting in the need for interventions that may be even more costly than specialty drug treatment, such as liver transplant, for example. Consequently, there is a need for a treatment recommendation solution that can determine a substantially optimal match of a patient to a medication or other therapeutic treatment, while concurrently identifying those patients who may be at the greatest risk of progressing to an advanced stage of the disease or condition from which they suffer without such treatment.

### SUMMARY

There are provided treatment recommendation systems and methods, substantially as shown in and/or described in connection with at least one of the figures, and as set forth more completely in the claims.

### BRIEF DESCRIPTION OF THE DRAWINGS

FIG. 1 shows a diagram of an exemplary treatment recommendation system, according to one implementation;

FIG. 2 shows another exemplary implementation of a treatment recommendation system;

FIG. 3 shows an exemplary system and a computer-readable non-transitory medium including instructions for generating one or more treatment recommendations;

FIG. 4 is a flowchart presenting an exemplary method for use by a system for generating one or more treatment recommendations;

FIG. 5 shows an exemplary patient risk forecast model input screen provided on a display of a treatment recommendation system, according to one implementation; and

FIG. 6 shows an exemplary treatment recommendation graphic provided on a display of a treatment recommendation system, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As noted above, advances in pharmaceutical and basic medical research have resulted in the availability of specialty drugs and new treatment protocols that give hope to many patients who previously had lacked effective treatment options. However, and as also noted above, many of these new treatments are extremely costly, and leave insurers and other entities responsible for paying for patient care in the unenviable position of facing unsustainable costs, or denying access to powerful and beneficial treatments.

The present application addresses the financial and ethical dilemmas described above, as well as analogous challenges in the provision of healthcare treatment, by providing treatment recommendation systems and methods designed to improve clinical outcomes for insurers and other healthcare payer entities, healthcare providers, and patients. According to one implementation, such a system and method may be used to reduce or eliminate waste by determining a substantially optimal match of a patient to a medication or other therapeutic treatment. Moreover, the systems and methods disclosed in the present application advantageously enable identification of those patients who may be at the greatest risk of progressing to an advanced stage of the disease or condition from which they suffer in the absence of treatment.

In some implementations, the treatments addressed by the disclosed treatment recommendation systems and methods may be relatively new prescription drugs, such as biologics or other costly specialty drugs. It is noted that for the purposes of the present application, a “biologic” or “biological medical product” is any pharmaceutical drug manufactured in, extracted from, or at least partially synthesized from biological sources, in contrast to traditional pharmaceutical drugs that are chemically synthesized. It is further noted that, as used herein, a “specialty drug” is a costly prescription medication, which may be chemically synthesized or produced as a biologic, and is used to treat complex, chronic conditions such as hepatitis C, cancer, multiple sclerosis, and rheumatoid arthritis, for example. The cost associated with use of a specialty drug may range from a few thousand dollars, up to approximately one hundred thousand dollars, or more, for a therapeutic course of treatment.

More generally, however, the treatment recommendations generated by the systems and according to the methods disclosed in the present application may be directed a wide variety of treatment modalities. That is to say, in some implementations, the treatment recommendation systems and methods disclosed in the present application may be utilized to analyze and recommend treatment types other than specialty drug treatment, and/or may evaluate fundamentally different treatment modalities against one another. Examples of other treatment modalities include immunotherapy, gene therapy, proton therapy, robotic surgical technologies, and even the more conventional use of common prescription medications, as well as established chemotherapy and x-ray therapy protocols, to name a few.

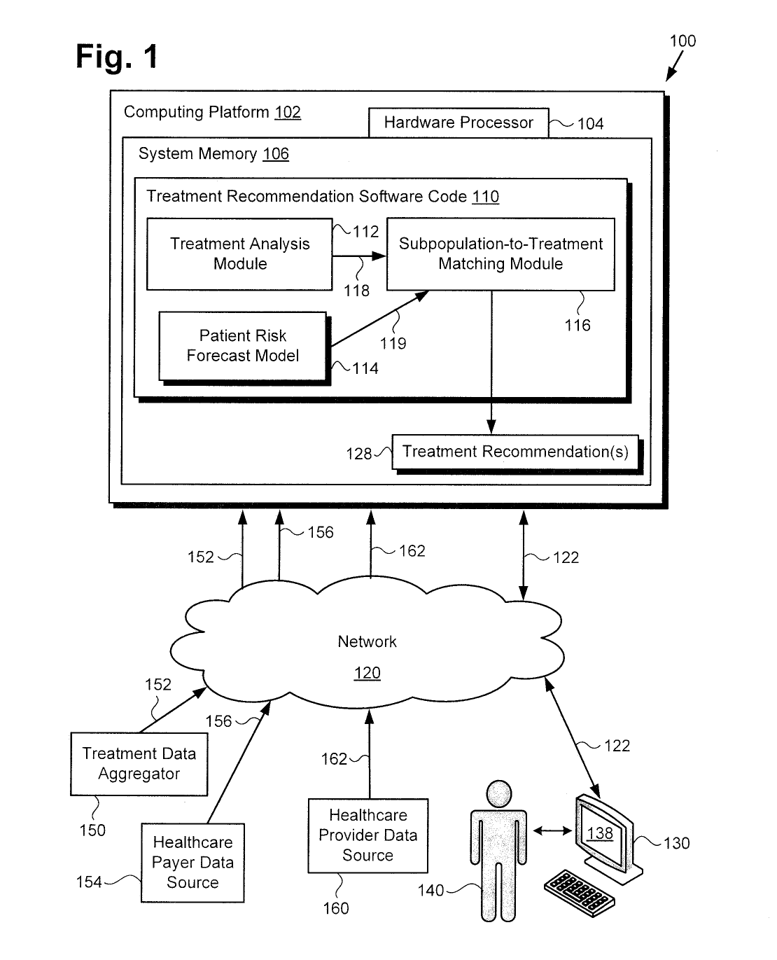

FIG. 1 shows a diagram of an exemplary treatment recommendation system, according to one implementation. Treatment recommendation system 100 includes computing platform 102 having hardware processor 104 and system memory 106 storing treatment recommendation software code 110. As shown in FIG. 1, treatment recommendation software code 110 includes treatment analysis module 112, patient-to-treatment matching module 116, patient risk forecast model 114, value scores 118 output by treatment analysis module 116, and risk 119 output by patient risk forecast model 114.

As further shown in FIG. 1, treatment recommendation system 100 is situated within a communications environment including communication network 120, client system 130 including display 138, system user 140, treatment data aggregator 150, healthcare payer data source 154, and healthcare provider data source 160. Also shown in FIG. 1 are treatment recommendation or recommendations (hereinafter “treatment recommendation(s)”) 128, network communication links 122 interactively connecting treatment recommendation system 100 with client system 130, and aggregated data 152, payer data 156, and provider data 162 received by treatment recommendation system 100 from treatment data aggregator 150, healthcare payer data source 154, and healthcare provider data source 160, respectively.

According to the implementation shown in FIG. 1, system user 140 may utilize client system 130 to interact with computing platform 102 of treatment recommendation system 100 over communication network 120. System user 140 may represent an insurer or other healthcare payer entity, and thus may be a utilization manager or coordinator, for example. Alternatively, system user 140 may be a healthcare provider, such as a physician, physician's assistant, pharmacist, or nurse practitioner, to name a few examples.

System user 140 may utilize client system 130 to access treatment recommendation software code 110 remotely, or to download treatment recommendation software code 110 to client system 130. In one such implementation, computing platform 102 may correspond to one or more web servers, accessible over a packet-switched network such as the Internet, for example. Alternatively, computing platform 102 may correspond to one or more servers supporting a local area network (LAN), or included in another type of limited distribution network.

It is noted that although FIG. 1 depicts treatment analysis module 112, patient-to-treatment matching module 116, and patient risk forecast model 114 of treatment recommendation software code 110 as being mutually co-located in system memory 106, that representation is merely provided as an aid to conceptual clarity.

More generally, treatment recommendation system 100 may include one or more computing platforms 102, such as computer servers for example, which may be co-located, or may form an interactively linked but distributed system, such as a cloud based system, for instance. As a result, hardware processor 104 and system memory 106 may correspond to distributed processor and memory resources within treatment recommendation system 100. Thus, it is to be understood that treatment analysis module 112, patient-to-treatment matching module 116, and patient risk forecast model 114 may be stored remotely from one another within the distributed memory resources of treatment recommendation system 100.

It is further noted that although FIG. 1 depicts treatment recommendation(s) 128 as residing in system memory 106, in some implementations, treatment recommendation(s) 128 may be copied to non-volatile storage (not shown in FIG. 1), or may be transmitted to client system 130 via communication network 120. Although client system 130 is shown as a personal computer (PC) in FIG. 1, that representation is provided merely as an example. In other implementations, client system 130 may be another type of personal communication device, such as a smartphone or tablet computer, for example. Moreover, display 138 of client system 130 may take the form of a liquid crystal display (LCD), a light-emitting diode (LED) display, an organic light-emitting diode (OLED) display, or another suitable display screen that performs a physical transformation of signals to light.

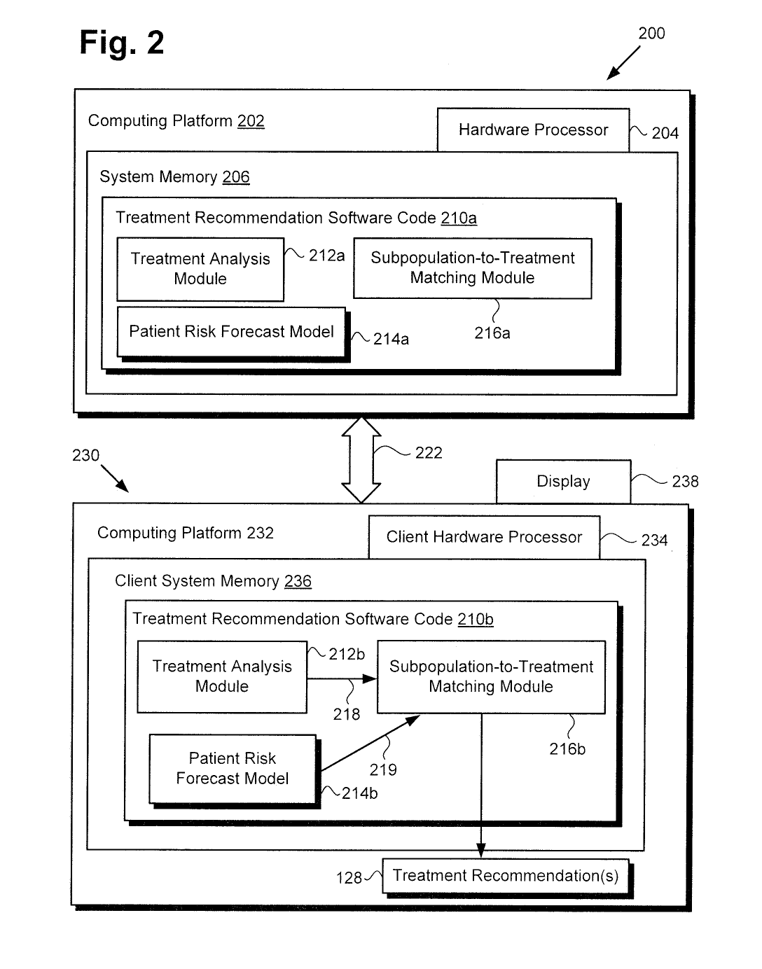

FIG. 2 shows an exemplary implementation of treatment recommendation system 200 in combination with a more detailed representation of client system 230.

Treatment recommendation system 200 includes computing platform 202, which is shown to be interactively connected to client system 230 via network communication link 222. Computing platform 202 includes hardware processor 204, and system memory 206 storing treatment recommendation software code 210a. As shown in FIG. 2, treatment recommendation software code 210a includes treatment analysis module 212a, patient-to-treatment matching module 216a, and patient risk forecast model 214a.

As further shown in FIG. 2, client system 230 includes display 238, and computing platform 232 having client hardware processor 234 and client system memory 236 storing treatment recommendation software code 210b including treatment analysis module 212b, patient-to-treatment matching module 216b, and patient risk forecast model 214b. Also shown in FIG. 2 are value scores 218, risk 219, and treatment recommendation(s) 228 generated by client system 230 using treatment recommendation software code 210b.

Network communication link 222, and treatment recommendation system 200 including computing platform 202 having hardware processor 204 and system memory 206, correspond in general to network communication link 122, and treatment recommendation system 100 including computing platform 102 having hardware processor 104 and system memory 106, in FIG. 1, and those corresponding features may share any of the characteristics attributed to either corresponding feature by the present disclosure.

In addition, treatment recommendation software code 210a including treatment analysis module 212a, patient-to-treatment matching module 216a, and patient risk forecast model 214a, in FIG. 2, corresponds in general to treatment recommendation software code 110 including treatment analysis module 112, patient-to-treatment matching module 116, and patient risk forecast model 114, in FIG. 1. In other words, treatment recommendation software code 210a, treatment analysis module 212a, patient-to-treatment matching module 216a, and patient risk forecast model 214a may share any of the characteristics attributed to corresponding treatment recommendation software code 110, treatment analysis module 112, patient-to-treatment matching module 116, and patient risk forecast model 114 by the present disclosure.

Client system 230 and display 238 correspond respectively in general to client system 130 and display 138, in FIG. 1, and those corresponding features may share any of the characteristics attributed to either corresponding feature by the present disclosure. Moreover, treatment recommendation software code 210b including treatment analysis module 212b, patient-to-treatment matching module 216b, and patient risk forecast model 214b corresponds in general to treatment recommendation software code 110/210a including treatment analysis module 112/212a, patient-to-treatment matching module 116/216a, and patient risk forecast model 114/214a. As a result, treatment recommendation software code 210b, treatment analysis module 212b, patient-to-treatment matching module 216b, and patient risk forecast model 214a may share any of the characteristics attributed to corresponding treatment recommendation software code 110/210a, treatment analysis module 112/212a, patient-to-treatment matching module 116/216a, and patient risk forecast model 114/214a by the present disclosure.

According to the exemplary implementation shown in FIG. 2, treatment recommendation software code 210b including treatment analysis module 212b, patient-to-treatment matching module 216b, and patient risk forecast model 214b is located in client system memory 236, having been received from computing platform 202 via network communication link 222. In one implementation, network communication link 222 corresponds to transfer of treatment recommendation software code 210b including treatment analysis module 212b, patient-to-treatment matching module 216b, and patient risk forecast model 214b over a packet-switched network, for example. Once transferred, for instance by being downloaded over network communication link 222, treatment recommendation software code 210b including treatment analysis module 212b, patient-to-treatment matching module 216b, and patient risk forecast model 214a may be persistently stored in client system memory 236, and may be executed locally on client system 230 by client hardware processor 234.

Client hardware processor 234 may be the central processing unit (CPU) for computing platform 232, for example, in which role client hardware processor 234 runs the operating system for client system 230 and executes treatment recommendation software code 210b. In the exemplary implementation of FIG. 2, a user of client system 230, such as system user 140, in FIG. 1, can utilize treatment recommendation software code 210b on client system 230 to determine value scores 218 and risk 219, as well as to generate treatment recommendation(s) 228.

It is noted that value scores 218, risk 219, and treatment recommendation(s) 228 correspond respectively in general to value scores 118, risk 119, and treatment recommendation(s) 128, in FIG. 1, and those corresponding features may share any of the characteristics attributed to either corresponding feature by the present application. Thus, according to the exemplary implementation shown in FIG. 2, client system 230 may function analogously to treatment recommendation system 100/200 and, like treatment recommendation system 100/200, may be utilized to generate one or more treatment recommendation(s) 128/228.

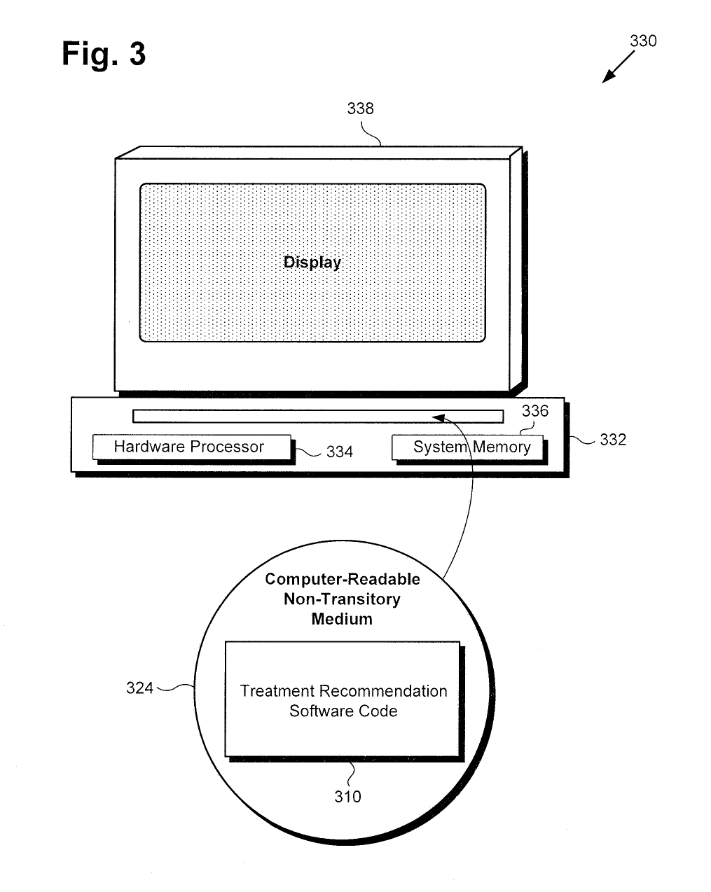

FIG. 3 shows an exemplary system and a computer-readable non-transitory medium including instructions for generating a treatment recommendation or recommendations, according to one implementation. System 330, in FIG. 3, includes computing platform 332 having hardware processor 334 and system memory 336, interactively linked to display 338. Display 338 may take the form of an LCD, LED display, an OLED display, or another suitable display screen that performs a physical transformation of signals to light. System 330 including display 338 and computing platform 332 having hardware processor 334 and system memory 336 corresponds in general to any or all of systems 100/130/200/230, in FIGS. 1 and 2, and those corresponding features may share the characteristics attributed to any corresponding feature by the present disclosure.

Also shown in FIG. 3 is computer-readable non-transitory medium 324 having treatment recommendation software code 310 stored thereon. The expression “computer-readable non-transitory medium,” as used in the present application, refers to any medium, excluding a carrier wave or other transitory signal, that provides instructions to hardware processor 334 of computing platform 332. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

According to the implementation shown in FIG. 3, computer-readable non-transitory medium 324 provides treatment recommendation software code 310 for execution by hardware processor 334 of computing platform 332. Treatment recommendation software code 310 corresponds in general to treatment recommendation software code 110/210a/210b, in FIG. 1/2, and is capable of performing all of the actions attributed to those corresponding features by the present disclosure. In other words, treatment recommendation software code 310 includes assets corresponding respectively to treatment analysis module 112/212a/212b, patient-to-treatment matching module 116/216a/216b, and patient risk forecast model 114/214a/214b. Moreover, treatment recommendation software code 310 may be used to generate a treatment recommendation or recommendations corresponding to treatment recommendation(s) 128/228.

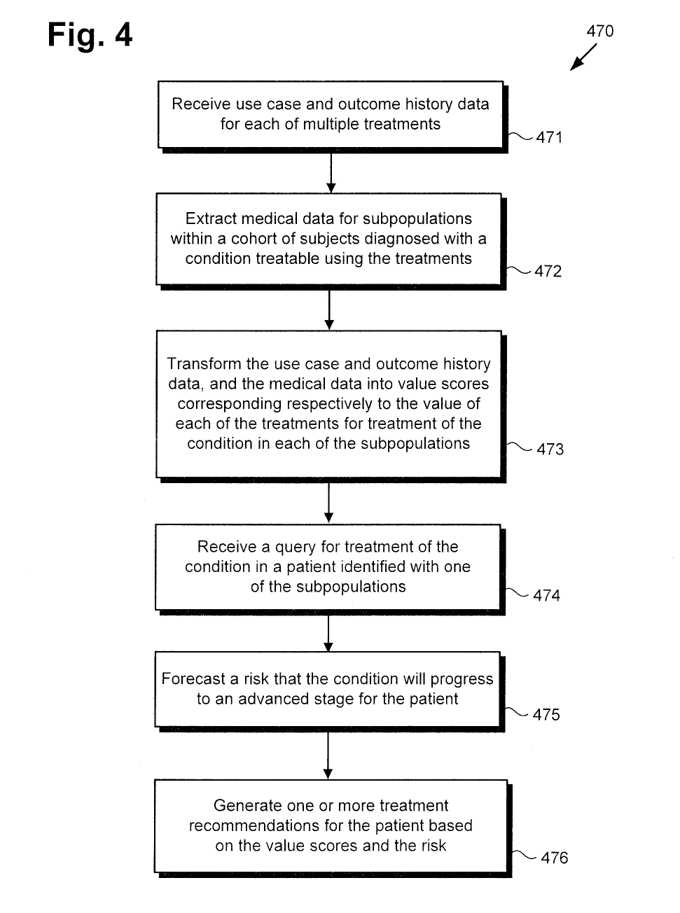

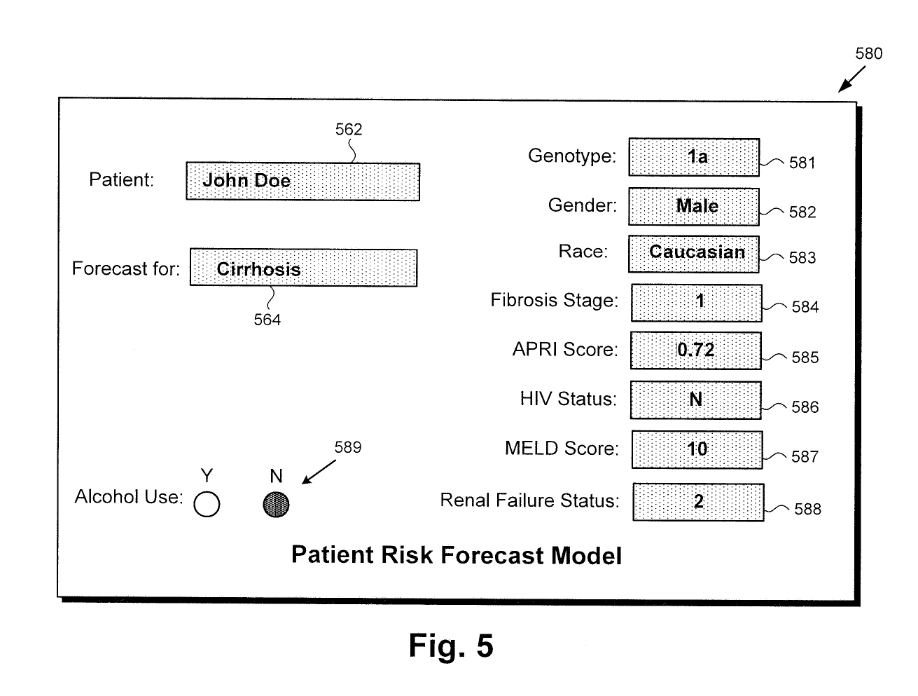

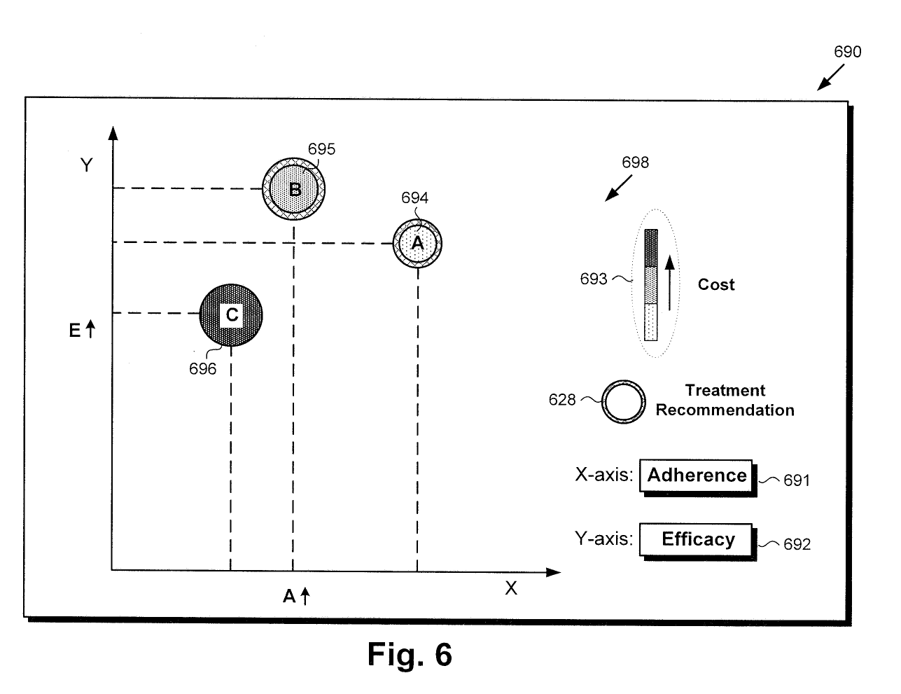

The treatment recommendation systems discussed above by reference to FIGS. 1, 2, and 3, will be further described below with reference to FIG. 4, FIG. 5, and FIG. 6. FIG. 4 presents flowchart 470 outlining an exemplary method for use by a system for generating one or more treatment recommendations. FIG. 5 shows exemplary patient risk forecast model input screen 580 provided on display 138/238/338 of treatment recommendation system 130/230/330, according to one implementation, while FIG. 6 shows exemplary treatment recommendation(s) 128/228 provided on display 138/238/338 of treatment recommendation system 130/230/330. With respect to the method outlined in FIG. 4, it is noted that certain details and features have been left out of flowchart 470 in order not to obscure the discussion of the inventive features in the present application.

Flowchart 470 begins with receiving use case data and outcome history data for each of one or more treatments (action 471). Referring to FIG. 1, any or all of aggregated data 152, payer data 156, and provider data 162 can include such use case data and outcome history data. For example, aggregated data 152 may include both payer data as described in 156 and provider data as described in 162. Aggregated data 152 may or may not be linked at the patient level. Payer data 156 may include claims data obtained from insurers or other healthcare payer entities, and may describe claims history for patients for whom any of the multiple treatments has been prescribed, as well as the costs associated with those treatments. Provider data 162 may include electronic medical records or laboratory data for patients having been treated using any of the multiple treatments, for example, which may have been redacted to protect the identities of individual patients.

Aggregated data 152 and/or payer data 156 and/or provider data 162 may be received by treatment recommendation software code 110/210a/210b/310 of system 100/130/200/230/330, executed by hardware processor 104/204/234/334. As shown in FIG. 1, aggregated data 152, payer data 156, and provider data 162 may be received by treatment recommendation software code 110/210a/210b/310 from respective treatment data aggregator 150, healthcare payer data source 154, and healthcare provider data source 160 via communication network 120.

Use case data may be data describing the circumstances surrounding application of a particular treatment. Use case data may include the condition being treated, the progression or staging of the condition, the particular treatment chosen, and a duration and/or a drug dosage used to treat the condition, to name a few examples. Outcome history data may be data recording the outcome of a treatment applied in a particular use case. Thus, outcome history data may include the remission or recurrence of the condition, a response timeline of the condition to the treatment, or a result of the treatment, such as recovery of the patient, death of the patient, or abandonment of the treatment, to name a few examples. In addition, outcome history data may include data derived from clinical trials of a particular treatment, and may include risks and other patient safety information obtained during the course of such clinical trials.

As noted above, the one or more treatments for which the use case data and the outcome history data may be received can include prescription drug treatments, including drug treatments utilizing biologics and/or other costly specialty drugs. However, as an alternative to, or in addition to, drug treatments, other treatments for which the use case data and the outcome history data may be received include immunotherapy, gene therapy, proton therapy, robotic surgical technologies, and even the more conventional use of common prescription medications, as well as established chemotherapy and x-ray therapy protocols, for example.

Flowchart 470 continues with extracting medical data for patient subpopulations within a cohort of subjects diagnosed with a condition treatable using the treatments for which use case history and outcome history have been received (action 472). Any or all of aggregated data 152, payer data 156, and provider data 162 can provide medical data, as well as the use case data and the outcome history data discussed by reference to action 471.

As stated above, aggregated data 152 and/or payer data 156 and/or provider data 162 may be received by treatment recommendation software code 110/210a/210b/310 of system 100/130/200/230/330, executed by hardware processor 104/204/234/334. In addition, aggregated data 152 and/or payer data 156 and/or provider data 162 may be processed by software code 110/210a/210b/310, executed by hardware processor 104/204/234/334, to extract the medical data for the various patient subpopulations. As further stated above, aggregated data 152, payer data 156, and provider data 162 may be received by treatment recommendation software code 110/210a/210b/310 via communication network 120.

Medical data may be data describing individual patients of a cohort of subjects having a diagnosis in common, and belonging to a common patient subpopulation. For example, medical data may include the age, gender, general health, and genotype of patients diagnosed with a condition treatable by the treatments for which use case data and outcome history data have been received. In addition, medical data can include any other patient characteristics considered to be relevant to a particular diagnosis.

As a specific but non-limiting example presented for the purposes of conceptual clarity, in a particular implementation in which the diagnosed condition treatable using the treatments for which use case data and outcome history data have been received is hepatitis C, medical data for patient subpopulations within the cohort of subjects diagnosed with hepatitis C may include several parameters. For instance, medical data for a particular patient subpopulation diagnosed with hepatitis C may include the genotype common to the patient subpopulation, whether the patients having the genotype in common have previously received some form of treatment for hepatitis C, and whether the patients having the genotype in common and sharing a common treatment history have presented with cirrhosis of the liver (hereinafter “cirrhosis”).

For the exemplary implementational situation described above, four different subpopulations of patients having the same genotype can give rise to four different sets of medical data corresponding to those subpopulations: (1) patients not previously receiving some form of hepatitis C treatment and without cirrhosis, (2) patients not previously receiving some form of hepatitis C treatment and presenting with cirrhosis, (3) patients having previously received some form of hepatitis C treatment and without cirrhosis, and (4) patients having previously received some form of hepatitis C treatment and presenting with cirrhosis. Each distinct genotype could analogously contribute to four different sets of medical data corresponding to four patient subpopulations.

As a specific exemplary use case, for the hepatitis C focused implementation discussed above, medical data may be extracted for thirty-two (32) distinct patient subpopulations within the cohort of subjects having hepatitis C as a common diagnosis. An exemplary list of those 32 patient subpopulations, as well as exemplary parameters for distinguishing among the subpopulations, is provided as Appendix A of the present application. In other implementations, however, the medical data extracted by treatment recommendation software code 110/210a/210b/310 may include more parameters, such as many more parameters, than the exemplary three parameters described above. Moreover, in implementations focused on treatment of other conditions, medical data may be extracted for more, or fewer, than the exemplary 32 distinct patient subpopulations identified for hepatitis C and listed in Appendix A.

It is noted that one significant challenge to processing aggregated data 152 and/or payer data 156 and/or provider data 162 to extract the medical data is the problem of data alignment. For example, medical data included in aggregated data 152 and/or payer data 156 and/or provider data 162 may be labeled differently, or may even be incorrectly labeled. In addition, in some instances, corresponding data between two or more of aggregated data 152, payer data 156, and provider data 162 may be absent, leading to the problem of incomplete data. To overcome these challenges, computing platform 102/202/232/332 may include an adaptable memory network data structure that advantageously enables alignment of those sometimes incomplete and/or misaligned and/or incorrectly defined data into proper alignment so that medical data identification and extraction is possible.

It is further noted that the number of parameters included in the medical data extracted by treatment recommendation software code 110/210a/210b/310 in action 472, as well as the number of identified patient subpopulations, can evolve as treatment recommendation software code 110/210a/210b/310 engages in machine learning. In other words, hardware processor 104/204/234/334 may further execute treatment recommendation software code 110/210a/210b/310 to adapt and improve its treatment recommendation functionality in response to future aggregated data 152 and/or payer data 156 and/or provider data 162 received from respective treatment data aggregator 150 and/or healthcare payer data source 154 and/or healthcare provider data source 160.

Flowchart 470 continues with transforming the use case data, the outcome history data, and the medical data into value scores 118/218 corresponding respectively to a value of each of the treatments for which the use case data and the outcome history data have been received, for treatment of the condition in each of the patient subpopulations for which medical data has been extracted (action 473). Transformation of the use case data, the outcome history data, and the medical data into value scores 118/218 may be performed by treatment recommendation software code 110/210a/210b/310 of system 100/130/200/230/330, executed by hardware processor 104/204/234/334, and using treatment analysis module 112/212a/212b.

In some implementations, the transformation of the use case data, the outcome history data, and the medical data into a value score 118/218 for a particular treatment and a particular patient subpopulation may be based on a combination of an efficacy of the treatment, an adherence of the treatment, and a safety record of the treatment in the patient subpopulation, for example.

For the purposes of the present application, treatment efficacy, or simply “efficacy” (E), is a measure of the effectiveness of the treatment based on real world evidence. Efficacy is defined as the percentage of patients within a particular patient subpopulation for whom remission or recovery occurs after completion of the treatment protocol. Returning to the example in which hepatitis C is the condition being treated, and where a particular treatment is drug therapy using “Drug A”, efficacy may be expressed as follows:

E(%)=N_{SVR}_{_}₁₂_{_}₀/N_{SP}*100 (Equation 1)

Where: SVR 12 is the Sustained Virological Response on a gap of twelve weeks after completion of a prescribed treatment period, N_{SVR}_{_}₁₂_{_}₀ is the number of patients within a subpopulation for whom SVR 12 is substantially zero, or negligible, and N₅ is the total number of patients in the patient subpopulation receiving the treatment.

Treatment adherence, or simply “adherence” (A), is a measure of the degree with which patients tend to comply with a particular treatment. In the case of drug treatment, one measure of adherence is the ratio of the drug dosage actually consumed by patients over a treatment period to the prescribed dosage over the treatment period. It is noted that adherence is an aggregated measure across all patients within a subpopulation receiving the same treatment. For example, adherence with respect to a drug treatment may be determined using the medication possession ratio (MPR), as known in the art, for a patient subpopulation treated using the same drug.

Treatment safety, or simply “safety” (S), may be determined based on the rate at which known complications of a particular treatment have historically manifested themselves in the patient subpopulation. Moreover, in some implementations, safety may be determined based on the costs associated with intervening to remedy those complications, or with a hospitalization rate of members of the patient subpopulation during or immediately after the treatment.

Value score (V) 118/218 of a particular treatment may be determined using a weighted or non-weighted combination of efficacy, adherence, and safety, as follows:

V=(w₁*E+w₂*A+w₃*S)/[100*(w₁+w₂+w₃)]*10 (Equation 2)

Where w₁, w₂, and w₃, are fractional weighting factors in a range between zero and one, inclusive of one, and are applied respectively to efficacy, adherence, and safety. It is noted that where value score 118/218 is determined using a non-weighted combination of efficacy, adherence, and safety, each of w₁, w₂, and w₃ may be set equal to one (w₁=w₂=w₃=1). It is further noted that in implementations in which value score 118/218 is determined using a weighted combination of efficacy, adherence, and safety, the weighting factors w₁, w₂, and w₃ may be predetermined and fixed within treatment recommendation software code 110/210a/210b/310, or may be selectable or adjustable by a user, such as system user 140. That is to say, in some implementations, system user 140 may have discretion to increase or reduce weighting factors w₁, w₂, and w₃ relative to one another.

In addition to efficacy, adherence, and safety, in some implementations, value score 118/218 may be further determined based on a cost of the treatment and/or overall utilization of the treatment among members of the patient subpopulation, for example. Treatment cost, or simply “cost” (C) is the cost of the treatment over the prescribed treatment period. For example, the cost of a drug treatment administered daily for ten weeks is the cumulative cost of the entire prescribed drug dosage over the ten week treatment period.

Treatment utilization, or simply “utilization” (U), is defined as the number of patients within a given patient subpopulation to whom a particular treatment has been prescribed, divided by the total number of patients making up the patient subpopulation. Thus, utilization of treatment “X” may be expressed as a percentage as follows:

U_{X}(%)=N_{X}/N_{TSP}*100 (Equation 3)

Where: N_{X} is the number of patients within the patient subpopulation to whom treatment X has been prescribed, and N_{TSP} is the total number of patients making up the patient subpopulation. It is noted that Equation 2 can be modified to include weighted or non-weighted contributions based on cost and/or utilization.

Thus, it is emphasized that in some implementations, system user 140 may select the variables included in Equation 2 and used to determine value score 118/218, and/or may select the weighting applied to the included variables by Equation 2. As a result, treatment recommendation software code 110/210a/210b/310 may be executed by hardware processor 104/204/234/334 to evaluate each treatment for each patient subpopulation in a way that balances the interests of the different parties, i.e., insurers or other healthcare payer entities, healthcare providers, and patients, affected by the resulting treatment recommendation.

Flowchart 470 continues with receiving a query for treatment of the condition treatable using the treatments for which use case history and outcome history have been received, in a patient identified with one of the patient subpopulations (action 474). Such a query may be received by treatment recommendation software code 110/210a/210b/310 of system 100/130/200/230/330, executed by hardware processor 104/204/234/334. For example, in the case of treatment recommendation software code 110/210a executed by hardware processor 104/204, the query may be received via communication network 120, over network communication link 122/222. Alternatively, in the case of treatment recommendation software code 210b/310 executed by hardware processor 234/334, the query may be received via inputs from system user 140 to client system 130/230 or to system 330.

The query may include identification of the condition for which treatment is being recommended, and patient data sufficient to evaluate the treatment, for example. It is noted that computing platform 102/202/232/332 is configured to run complex queries on often large datasets based on a large number of variables. Computing platform 102/202/232/332 includes optimizations in memory networking to enable real-time responsiveness with respect to receipt of a query from system user 140.

For example, in some implementations, computing platform 102/202/232/332 includes an adaptable memory network to run the queries a priori and hashes the results in a hash table. Based on the queries, database access can be substantially minimized, thereby advantageously enabling treatment recommendation system 100/130/200/230/330 to respond more quickly. Such an implementation effectively results in an adaptable hardware implementation of a software cache.

Flowchart 470 continues with forecasting risk 119/219 that the condition will progress to an advanced stage for the patient who is the subject of the query (action 475). Forecasting of risk 119/219 may be performed by treatment recommendation software code 110/210a/210b/310 of system 100/130/200/230/330, executed by hardware processor 104/204/234/334, and using patient risk forecast model 114/214a/214b.

Continuing with the hepatitis C focused exemplary implementation introduced above, the presence of cirrhosis in a patient having hepatitis C can foreshadow or accompany progression to advanced liver disease. As a result, patients who are not yet cirrhotic but for whom the development of cirrhosis is likely, as well as those presenting with cirrhosis, are at higher risk of having their condition progress to advanced liver disease. Thus, in implementations in which the condition for which a treatment recommendation is sought is hepatitis C, patient risk forecast model 114/214a/214b may be used to forecast risk 119/219 that a patient as yet not presenting with cirrhosis, will develop cirrhosis, and is thereby likely to progress to advanced liver disease, perhaps requiring liver transplant.

In some implementations, treatment recommendation software code 110/210a/210b/310 may utilize patient risk forecast model 114/214a/214b to forecast risk 119/219 based on predetermined the cirrhosis predictive parameters. For example, in one implementation, the following parameters may be predetermined to by cirrhosis predictive parameters (pᵢ) for use in forecasting risk 119/219:
pᵢ=Gender
p₂=Fibrosis Stage
p₃=Race
p₄=APRI (Aspartate Aminotranferase to Platelet Ratio Index) Score
p₅=Consumption of Alcohol
p₆=HIV (Human Immunodeficiency Virus) Status
p₇=MELD (Model for End-Stage Liver Disease) Score
p₈=Status of Renal Failure

Risk 119/219 may be forecast using a weighted combination of such cirrhosis predictive parameters, for example. The values of those weighting factors may be determined through an initial training of patient risk forecast model 114/214a/214b. As an example, cirrhosis prediction data structure 114/214 of initially trained cirrhosis forecast model 112/212 may include the following expression for the probability that cirrhosis is present or substantially imminent for a subject:

$$\begin{matrix}Cirrhosis Risk 119 / 219 = 1 / ( 1 + {e}^{- K} ) & ( Equation 4 ) \\ With : K = C + {\sum }_{1}^{N} {w}_{i} {p}_{i} & ( Equation 5 )\end{matrix}$$

Where C is a constant, the pᵢ are the cirrhosis predictive parameters identified above, and the wᵢ are their respective weighting factors determined using logistic regression.

As an even more specific example, when the exemplary cirrhosis predictive parameters listed above on are a complete set of cirrhosis predictive parameters, K may take the form:

K=C+w₁p₁+w₂p₂+w₃p₃+w₄p₄+w₅p₅+w₆p₆+w₇p₇+w₈p₈ (Equation 5.1)

FIG. 5 shows exemplary input screen 580 provided on display 138/238/338 of treatment recommendation system 130/230/330, according to one implementation. As shown by FIG. 5, input screen 580 enables system user 140 to identify patient 562 and risk state 564 by entering a patient identifier and a condition identifier in their respective fields. According to the exemplary implementation of FIG. 5, patient 562 and risk state 564 are identified by name. However, in other implementations, patient 562 and risk state 564 may be identified using other types of identifiers, such as by a respective patient identification number and diagnostic code, for example.

As shown in FIG. 5, according to the present exemplary implementation, system user 140 has identified patient 562 as John Doe and has identified risk state 564 as cirrhosis. Based on the identification of risk state 564 as cirrhosis, input screen 580 prompts system user 140 to enter values for various cirrhotic predictive parameters by providing a respective field for each parameter. For example, and as further shown in FIG. 5, in addition to genotype field 581, input screen 580 provides gender field 582, race field 583, fibrosis stage field 584, APRI score field 585, HIV status field 586, MELD score field 587, renal failure status field 588, and alcohol use radio buttons 589 corresponding respectively to cirrhosis predictive parameters p₁, p₂, p₃, p₄, p₅, p₆, p₇, and p₈, above.

It is reiterated that the exemplary risk forecasting described above by reference to action 475 and FIG. 5 may be appropriate for the exemplary use case in which the condition for which treatment recommendation(s) 128/228 is/are sought is hepatitis C, and the risk being forecast is that of the development of cirrhosis in a presently non-cirrhotic patient. However, in use cases in which other conditions are the subject of treatment recommendation(s) 128/228, parameters and equations other than those expressly described above, and that are more suitable for the particular condition at issue, may be used.

In some implementations, flowchart 470 may conclude with generating one or more treatment recommendation(s) 128/228 for the patient based on value scores 118/218 and risk 119/219 (action 476). Treatment recommendation(s) 128/228 may be generated by treatment recommendation software code 110/210a/210b/310 of system 100/130/200/230/330, executed by hardware processor 104/204/234/334, and using patient-to-treatment matching module 116/216a/214b.

FIG. 6 shows exemplary treatment recommendation graphic 690 provided on display 138/238/338 of treatment recommendation system 130/230/330, according to one implementation. As shown in FIG. 6, treatment recommendation graphic 690 includes graph 698 plotting adherence A on the X-axis, and efficacy E on the y-axis. As further shown in FIG. 6 system user 140 can select the variables plotted on graph 698 using X-axis selector 691 and Y-axis selector 692.

It is noted that although the exemplary implementation shown in FIG. 6 depicts graph 698 of efficacy and adherence, in other implementations, system user 140 can select other variables for presentation on graph 698. For example, any of efficacy, adherence, safety, cost, or utilization could be plotted on the X-axis by selecting that variable using X-axis selector 691, and any other of efficacy, adherence, safety, cost, or utilization could be plotted on the Y-axis by selecting that other variable using Y-axis selector 692.

Also shown in FIG. 6 is data circle 694 corresponding to a “Treatment A”, data circle 695 corresponding to a “Treatment B”, and data circle 696 corresponding to a “Treatment C.” According to the present exemplary implementation, the size or color of each of data circles 694, 695, and 696 i.e., their respective diameters or line fills in FIG. 6, correspond to the cost of those respective treatments, as shown by cost key 693. In addition, treatment recommendation graphic 690 identifies “Treatment A” and “Treatment B” as treatment recommendations 128/228 by surrounding data circle 694 corresponding to “Treatment A” and data circle 695 corresponding to “Treatment B” with a respective recommendation ring 628.

It is noted that, “Treatment A” has the highest adherence among treatments “A”, “B”, and “C”, the lowest cost among treatments “A”, “B”, and “C”, and a relatively high efficacy. Consequently, if treatment recommendation(s) 128/228 were generated based on value scores 118/218 substantially alone, either because risk 119/219 is very low or is disregarded, “Treatment A” would likely be recommended to the exclusion of treatments “B” and “C” due to its substantially lower cost. In other words, use of a treatment recommendation system that does not consider risk 119/219 may result in approval of “Treatment A” for a patient, but denial of “Treatment B” having the highest efficacy, due to its higher cost.

However, according to the present inventive principles, risk 119/219 to the patient is factored in to generating treatment recommendation(s) 128/228. Assuming that risk 119/219 is forecast as being relatively high for the patient for whom the query was received in action 474, highest efficacy “Treatment B” is also a recommended treatment, despite its relatively high cost. Consequently, use of system 100/130/200/230/330 to generate treatment recommendation 128/228 can advantageously result in approval of “Treatment B” for the patient due to identification of the patient as being especially in need of a highly effective treatment.

Thus, the systems and methods disclosed in the present application address serious financial and ethical dilemmas posed by decisions to permit or deny patient access to extremely costly but highly effective treatments. The disclosed systems and methods may be used to reduce or eliminate waste by determining a substantially optimal match of a patient to a medication or other therapeutic treatment. In addition, the systems and methods disclosed in the present application advantageously enable identification of those patients who may be at the greatest risk of progressing to an advanced stage of the disease or condition from which they suffer. Consequently, the systems and methods disclosed in the present application can play an important role in enabling seriously and/or chronically ill patients to have greater access to effective treatments for the conditions that afflict them, thereby improving clinical outcomes for insurers, healthcare providers, and patients alike.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

APPENDIX A

| Genotype | Treatment | Cirrhosis | Patient Subpopulation | |
|---|---|---|---|---|
| 1a | Experienced | No | 1. | 1a Experienced |
| 1a | Experienced | Yes | 2. | 1a Experienced cirrhosis |
| 1a | Experienced | No | 3. | 1a Experienced Non |
| | | | | Responsive |
| 1a | Experienced | No | 4. | 1a Experienced Partial |
| | | | | Response |
| 1a | Experienced | No | 5. | 1a Experienced Relapsed |
| 1a | Naive | No | 6. | 1a N Naive |
| 1a | Naive | | 7. | 1a Naive < 6 million |
| 1a | Naive | Yes | 8. | 1a Naive cirrhosis |
| 1b | Experienced | No | 9. | 1b Experienced |
| 1b | Experienced | Yes | 10. | 1b Experienced cirrhosis |
| 1b | Naive | No | 11. | 1b Naive |
| 1b | Naive | Yes | 12. | 1b Naive cirrhosis |
| 2 | Experienced | No | 13. | 2 Experienced |
| 2 | Experienced | Yes | 14. | 2 Experienced cirrhosis |
| 2 | Naive | No | 15. | 2 Naive |
| 2 | Naive | Yes | 16. | 2 Naive cirrhosis |
| 3 | Experienced | No | 17. | 3 Experienced |
| 3 | Experienced | Yes | 18. | 3 Experienced cirrhosis |
| 3 | Naive | No | 19. | 3 Naive |
| 3 | Naive | Yes | 20. | 3 Naive cirrhosis |
| 4 | Experienced | No | 21. | 4 Experienced |
| 4 | Experienced | Yes | 22. | 4 Experienced cirrhosis |
| 4 | Naive | No | 23. | 4 Naive |
| 4 | Naive | Yes | 24. | 4 Naive cirrhosis |
| 5 | Experienced | No | 25. | 5 Experienced |
| 5 | Experienced | Yes | 26. | 5 Experienced cirrhosis |
| 5 | Naive | No | 27. | 5 Naive |
| 5 | Naive | Yes | 28. | 5 Naive cirrhosis |
| 6 | Experienced | No | 29. | 6 Experienced |
| 6 | Experienced | Yes | 30. | 6 Experienced cirrhosis |
| 6 | Naive | No | 31. | 6 Naive |
| 6 | Naive | Yes | 32. | 6 Naive cirrhosis |

What is claimed is:

1. A treatment recommendation system comprising:
a computing platform including a hardware processor and a system memory;
a treatment recommendation software code stored in the system memory;
wherein the hardware processor is configured to execute the treatment recommendation software code to:
receive use case and outcome history data for each of a plurality of treatments;
extract medical data for a plurality of subpopulations within a cohort of subjects diagnosed with a condition treatable using the plurality of treatments;
transform the use case and outcome history data and the medical data into value scores corresponding respectively to a value of each of the plurality of treatments for treatment of the condition in each of the plurality of subpopulations;
receive a query for treatment of the condition in a patient identified with one of the plurality of subpopulations;
forecast a risk of the condition progressing to an advanced stage for the patient; and
generate at least one treatment recommendation for the patient based on the value scores and the risk.

2. The treatment recommendation system of claim 1, wherein the treatments comprise prescription drugs.

3. The treatment recommendation system of claim 1, wherein the treatments comprise specialty prescription drugs.

4. The treatment recommendation system of claim 1, wherein the treatments comprise biologics.

5. The treatment recommendation system of claim 1, wherein the use case and outcome history data and the medical data are transformed into the value score for each of the plurality of treatments based on a combination of an efficacy of the treatment, an adherence of the treatment, and a safety record of the treatment in the respective subpopulation.

6. The treatment recommendation system of claim 5, wherein the value score of the treatment is further determined based on a cost of the treatment.

7. The treatment recommendation system of claim 1, wherein the condition is hepatitis C.

8. A method for use by a system for recommending a treatment, the system comprising a computing platform including a hardware processor and a system memory having a treatment recommendation software code stored therein, the method comprising:
receiving, using the hardware processor, use case and outcome history data for each of a plurality of treatments;
extracting, using the hardware processor, medical data for a plurality of subpopulations within a cohort of subjects diagnosed with a condition treatable using the plurality of treatments;
transforming, using the hardware processor, the use case and outcome history data and the medical data into value scores corresponding respectively to a value of each of the plurality of treatments for treatment of the condition in each of the plurality of subpopulations;
receiving, using the hardware processor, a query for treatment of the condition in a patient identified with one of the plurality of subpopulations;
forecasting, using the hardware processor, a risk of the condition progressing to an advanced stage for the patient; and
generating, using the hardware processor, at least one treatment recommendation for the patient based on the value scores and the risk.

9. The method of claim 8, wherein the treatments comprise prescription drugs.

10. The method of claim 8, wherein the treatments comprise specialty prescription drugs.

11. The method of claim 8, wherein the treatments comprise biologics.

12. The method of claim 8, wherein transforming the use case and outcome history data and the medical data into the value score for each of the plurality of treatments is based on a combination of an efficacy of the treatment, an adherence of the treatment, and a safety record of the treatment in the respective subpopulation.

13. The method of claim 12, wherein the value score of the treatment is further determined based on a cost of the treatment.

14. The method of claim 8, wherein the condition is hepatitis C.

15. A computer-readable non-transitory medium having stored thereon instructions, which when executed by a hardware processor, instantiate a method comprising:
receiving use case and outcome history data for each of a plurality of treatments;
extracting medical data for a plurality of subpopulations within a cohort of subjects diagnosed with a condition treatable using the plurality of treatments;
transforming the use case and outcome history data and the medical data into value scores corresponding respectively to a value of each of the plurality of treatments for treatment of the condition in each of the plurality of subpopulations;
receiving a query for treatment of the condition in a patient identified with one of the plurality of subpopulations;
forecasting a risk of the condition progressing to an advanced stage for the patient; and
generating at least one treatment recommendation for the patient based on the value scores and the risk.

16. The computer-readable non-transitory medium of claim 15, wherein the treatments comprise prescription drugs.

17. The computer-readable non-transitory medium of claim 15, wherein the treatments comprise specialty prescription drugs.

18. The computer-readable non-transitory medium of claim 15, wherein the treatments comprise biologics.

19. The computer-readable non-transitory medium of claim 15, wherein transforming the use case and outcome history data and the medical data into the value score for each of the plurality of treatments is based on a combination of an efficacy of the treatment, an adherence of the treatment, and a safety record of the treatment in the respective subpopulation.

20. The computer-readable non-transitory medium of claim 19, wherein the value score of the treatment is further determined based on a cost of the treatment.
